(19) United States
(12) Patent Application Publication
(10) Pub. No.: US 2025/0184218 A1
(43) Pub. Date: Jun. 5, 2025

(54) COMMUNICATION APPARATUS, COMPUTER-READABLE STORAGE MEDIUM, AND COMMUNICATION SYSTEM

(71) Applicant: BROTHER KOGYO KABUSHIKI KAISHA, Nagoya (JP)

(72) Inventor: Takatsugu YAMADA, Nagoya (JP)

(21) Appl. No.: 18/960,215

(22) Filed: Nov. 26, 2024

(30) Foreign Application Priority Data
Nov. 30, 2023 (JP) 2023-203382

(51) Int. Cl. H04L 41/0806; H04L 51/18

(52) U.S. Cl. CPC H04L 41/0806; H04L 51/18

(57) ABSTRACT

A communication apparatus includes a communication interface and a controller. The controller is configured to, in response to power supply to the communication apparatus, determine whether an initial-setting process in the communication apparatus is completed or incomplete; in response to determining that the initial-setting process is incomplete, wait for an execution instruction for executing the initial-setting process for the communication apparatus with use of an external terminal; and in response to receiving the execution instruction from the external terminal through the communication interface while waiting for the execution instruction, execute the initial-setting process for the communication apparatus.

### REFERENCE TO RELATED APPLICATIONS

This application claims priority from Japanese Patent Application No. 2023-203382, filed on Nov. 30, 2023. The entire content of the priority application is incorporated herein by reference.

### BACKGROUND ART

A setup assisting method to assist a user to set up a computer so that the computer is enabled to work in cooperation with an external device is known. According to the setup assisting method, the computer may be driven to execute a setup guiding program stored in a CD-ROM set in a CD-ROM drive of the computer. By executing the setup guiding program, guidance information showing a setup procedure may be displayed to the user through a display device. A controller in the computer may update values of flags stored in a hard disk drive as the setup procedure progresses. Later, when the computer executes the setup guiding program again, the controller may display the guidance information according to the updated values of the flags stored in the hard disk drive.

### SUMMARY

According to the known setup assisting method, the user may set the CD-ROM in the CD-ROM drive, and the computer may activate a setup guiding program stored in the CD-ROM before the user is provided with guidance information indicating a setup procedure displayed in a display device.

The present disclosure relates to a technique that reduces the initial setting operations required for setting up a communication apparatus by a user of an external terminal.

According to an aspect of the present disclosure, a communication apparatus includes a communication interface and a controller. The controller is configured to, in response to power supply to the communication apparatus, determine whether an initial-setting process in the communication apparatus is completed or incomplete; in response to determining that the initial-setting process is incomplete, wait for an execution instruction for executing the initial-setting process for the communication apparatus with use of an external terminal; and in response to receiving the execution instruction from the external terminal through the communication interface while waiting for the execution instruction, execute the initial-setting process for the communication apparatus.

According to another aspect of the present disclosure, a non-transitory computer-readable storage medium stores computer readable instructions that are executable by a computer in a terminal device including a communication interface. The computer readable instructions, when executed by the computer, cause the terminal device to send an inquiry to request a completion status of an initial-setting process for a communication apparatus through the communication interface, and in response to receiving a reply indicating with the completion status indicating that the initial-setting process is incomplete from the communication apparatus, transmit an execution instruction instructing the communication apparatus to execute the initial-setting process to the communication apparatus.

According to another aspect of the present disclosure, a communication system includes a communication apparatus including a first communication interface and a controller, and a terminal device including a second communication interface. The controller in the communication apparatus is configured to, in response to power supply to the communication apparatus, determine whether an initial-setting process in the communication apparatus is completed or incomplete, and in response to determining that the initial-setting process is incomplete, wait for an execution instruction for executing the initial-setting process for the communication apparatus with use of the terminal device. The terminal device is configured to transmit the execution instruction instructing the communication apparatus to execute the initial-setting process through the second communication interface. The controller in the communication apparatus is configured to, in response to receiving the execution instruction from the terminal device through the first communication interface while waiting for the execution instruction, execute the initial-setting process for the communication apparatus.

### BRIEF DESCRIPTION OF DRAWINGS

FIG. 1 is a block diagram to illustrate an overall configuration of a communication system.

FIGS. 2A-2B are flowcharts illustrating a part of steps in a powered-on process to be executed by a CPU in an MFP in the communication system.

FIG. 3 is a flowchart illustrating another part of the steps in the powered-on process to be executed by the CPU in the MFP in the communication system.

FIG. 4 is a flowchart illustrating steps in a replying process to be executed by the CPU in the MFP in the communication system.

FIG. 5 is a flowchart illustrating steps in an inquiring process to be executed by a CPU in a mobile terminal in the communication system.

FIG. 6A illustrates screens to be displayed on LCDs of the MFP and the mobile terminal in the communication system. FIG. 6B illustrates a setup-in-different-method screen to be displayed on the LCD of the MFP in the communication system.

FIG. 7 illustrates screens to be displayed on the LCDs of the MFP and the mobile terminal in the communication system shifting from the screens shown in FIG. 6A.

FIG. 8 illustrates the MFP and screens to be displayed on the LCDs of the MFP and the mobile terminal 10 in the inquiring process under a specific condition.

FIG. 9 illustrates the MFP and screens to be displayed on the LCDs of the MFP and the mobile terminal 10 in the inquiring process under another specific condition.

### DESCRIPTION

Hereinbelow, an embodiment of the present disclosure will be described in detail.

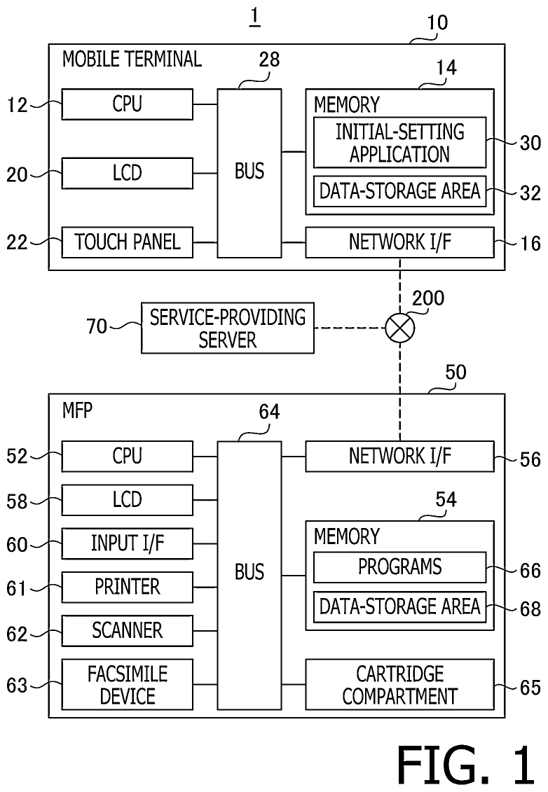

FIG. 1 is a block diagram to illustrate an overall configuration of a communication system 1 according to an embodiment of the present disclosure. As shown in FIG. 1, the communication system 1 includes a mobile terminal 10 being an example of the external terminal and an MFP 50 being an example of the communication apparatus. The term MFP is an abbreviation of Multi-Function Peripheral machine.

The mobile terminal 10 and the MFP 50 are connected to a network 200. The network 200 may be any of the Internet, a local area network (LAN), and a combination of the Internet and LAN. The network 200 may be a wired network, a wireless network, or a combination of wired and wireless networks. In the present embodiment, the mobile terminal 10 and the MFP 50 are connected wirelessly through a router (not shown), which composes a part of the network 200. Moreover, a service-providing server 70 is connected to the network 200.

The mobile terminal 10 includes a CPU 12, a memory 14, a network interface (I/F) 16, an LCD 20, and a touch panel 22, which are connected to communicate with one another through a bus 28. The mobile terminal 10 may be, but not necessarily, for example, a smartphone. For another example, the mobile terminal 10 may be a tablet device or a laptop computer. The configuration of the mobile terminal 10 shown in FIG. 1 is merely an example. Optionally, the mobile terminal 10 may include a mobile communication I/F for communicating wirelessly with a mobile base station and a camera for capturing images.

The CPU 12 is configured to execute a process for initial settings of the mobile terminal 10 according to an initial-setting application 30 stored in the memory 14. The initial-setting application 30 may not initially be stored in the memory 14 of the mobile terminal 10 but may be downloaded from, for example, the service-providing server 70 and installed in the mobile terminal 10 to be executed. The CPU 12 may execute the initial-setting application 30 to set a password for an administrator of the MFP 50, set time in the MFP 50, and control the LCD 20 to display guidance for the initial settings. In the description below, the CPU 12 to execute the initial-setting application 30 may be referred to by a name of the application program to be executed. For example, a phrase such as “the initial-setting application 30 controls” may equate to “the CPU 12 executing the initial-setting application 30 controls.”

The memory 14 includes a data-storage area 32. The data-storage area 32 is an area to store data that may be required by the CPU 12 to execute the initial-setting application 30.

The network I/F 16 is a communication interface enabling wired or wireless communication with a network I/F 56 of the MFP 50 connected to the network 200. The network I/F 16 includes chips and circuits that comply with the communication standards of the wired or wireless LAN. The mobile terminal 10 and the MFP 50 may exchange electric data through, for example, Wi-Fi. Wi-Fi is a networking technology of wireless LAN and is a registered trademark of Wi-Fi Alliance. However, the communication method between the mobile terminal 10 and the MFP 50 is not necessarily limited. For example, the mobile terminal 10 and the MFP 50 may communicate wirelessly through Bluetooth or NFC. Bluetooth is a registered trademark of Bluetooth SIG, Inc., and NFC is a registered trademark of NFC Forum, Inc.

The LCD 20 includes a display screen, on which functions of the mobile terminal 10 may be displayed. The touch panel 22 includes touch sensors arrayed to cover the display screen of the LCD 20. The touch panel 22 may detect approaching or contacting behaviors of a user's fingers or a touch-pen and output electrical signals according to the detected behaviors.

Meanwhile, the MFP 50 includes a CPU 52, a memory 54, the network I/F 56, an LCD 58, an input I/F 60, a printer 61, a scanner 62, a facsimile device 63, and a cartridge compartment 65, which are connected to communicate with one another through a bus 64.

The CPU 52 executes processes in accordance with programs 66 stored in the memory 54. The programs 66 include, for example, application programs to execute a printing process and a scanning process and application programs to initially set the MFP 50 according to instructions from the initial-setting application 30 on the mobile terminal 10. The memory 54 includes a data-storage area 68, which is an area to store data required by the CPU 52 to execute the programs 66.

The memory 14 in the mobile terminal 10 is composed of RAM, ROM, flash memory, HDD, and a buffer in the CPU 12. The memory 54 in the MFP 50 is composed of RAM, ROM, flash memory, HDD, and a buffer in the CPU 52. The memory 54 in the MFP 50 and the memory 14 in the mobile terminal 10 may be the computer-readable storage medium storing information readable by the CPU 52 and the CPU 12, respectively. The storage medium storing information readable by the CPU 52 and the CPU 12 is a non-transitory medium, which is a tangible medium. The non-transitory medium may include storage medium such as, for example, CD-ROM and DVD-ROM. Meanwhile, electrical signals conveying a program downloadable through the Internet, for example, from a server, may form a computer-readable signal medium but may not form a non-transitory computer-readable storage medium.

The network I/F 56 of the MFP 50 is a communication interface enabling wired or wireless communication with the network I/F 16 of the mobile terminal 10 and includes chips and circuits that comply with the communication standards of the wired or wireless LAN.

The LCD 58 includes a display screen, on which functions of the MFP 50 may be displayed. The input I/F 60 is a touch panel formed integrally with the LCD 58 and may receive input from a user operating icons or buttons displayed on the display screen of the LCD 58. Additionally or alternatively to the touch panel, the input I/F 60 may include hardware keys.

The printer 61 may form an image on a sheet, e.g., a paper sheet or an OHP film. The printer 61 may be an electro-photographic printer including an exposure unit, a photosensitive member, a developing roller, and a fuser. The printer 61 may be an inkjet printer including an inkjet head, a carriage, and a carriage-driving device. The MFP 50 may receive a print instruction from the mobile terminal 10 and operate the printer 61 to print an image based on printable image data included in the received print instruction. The scanner 62 includes a reading sensor that may read an image on an original material. The MFP 50 may receive a scan instruction from the mobile terminal 10, generate scan data composing the image having been read with the scanner 62, and transmit the generated scan data to the mobile terminal 10. The facsimile device 63 may perform a facsimile transmitting/receiving process according to a predetermined protocol.

The cartridge compartment 65 is formed to accommodate a cartridge storing a colorant, such as ink or toner that may color the sheet. The cartridge compartment 65 includes a detection sensor, which may detect the cartridge being attached to the cartridge compartment 65. Alternatively, the MFP 50 may have a tank to store the colorant in place of the cartridge compartment 65. The tank may have an inlet, and the user may pour the colorant from a bottle through the inlet port to load the tank with the colorant. Moreover, the tank may include a detection sensor, which may detect whether an amount of the colorant stored in the tank is greater than a predetermined threshold amount.

The service-providing server 70 includes a CPU, a memory, a network I/F, an LCD, and an input I/F, which may operate substantially similarly to those in the mobile terminal 10 or the MFP 50. The service-providing server 70 may provide various types of services, such as a remote-printing function, with use of a communication apparatus including the MFP 50, to the user of the communication apparatus. The remote-printing function is a function that enables the MFP 50 to print an image based on printable data received from a terminal device connected to the network 200 through the service-providing server 70. The service-providing server 70 may, as explained earlier, store the initial-setting application 30 therein and transmit the initial-setting application 30 in response to a request from the mobile terminal 10. However, the initial-setting application 30 may not necessarily be stored in the service-providing server 70 but may be stored in a different server, and the mobile terminal 10 may access the different server and download the initial-setting application 30 therefrom.

The embodiment described in the paragraphs below will explain processes to be executed by the CPUs 12, 52 according to instructions described in the programs. In the explanation, terms to express acts in the mobile terminal 10, the MFP 50, and the service-providing server 70 such as judging, selecting, calculating, determining, specifying, obtaining, receiving, and controlling may represent processes executed by the CPUs, or controllers. The processes to be executed by the CPUs include controlling over hardware devices through OSes. Meanwhile, an act of obtaining may not necessarily be induced by an act of requesting. In other words, the CPUs may receive data without requesting, and the act of receiving may still be expressed as “the CPU obtains the data.” Moreover, a term “data” in the present disclosure may mean a bit string readable by a computer. Data units containing substantially the same contents but in different formats may be regarded as a same data unit, and a term “information” may be regarded similarly.

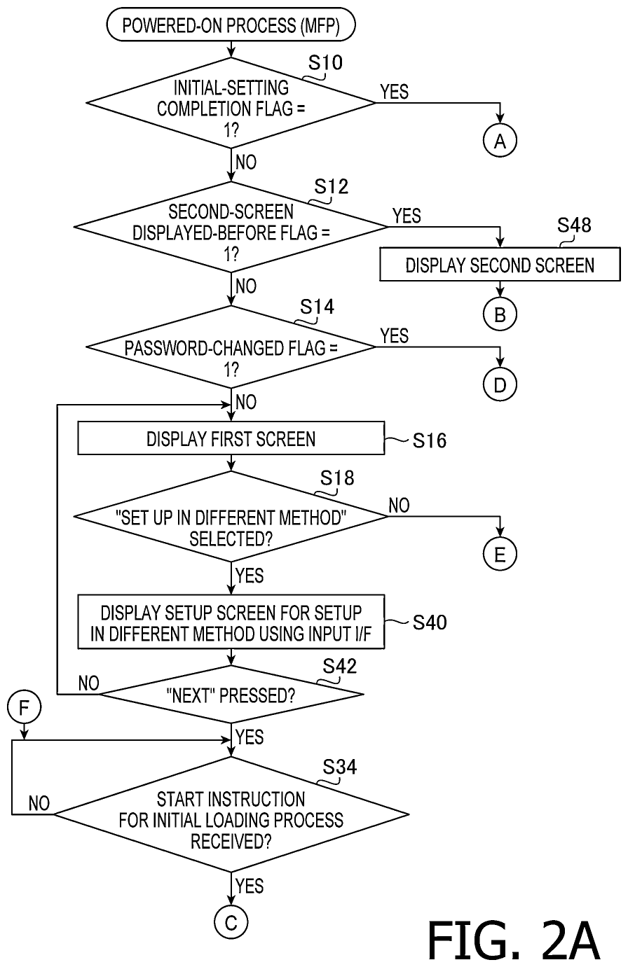

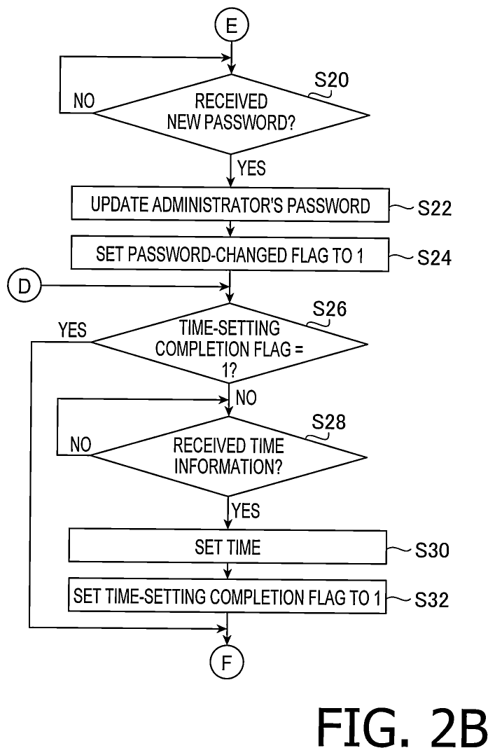

The controlling processes to be executed in the communication system 1 as configured above will be described below with reference to FIGS. 2A-2B through 9.

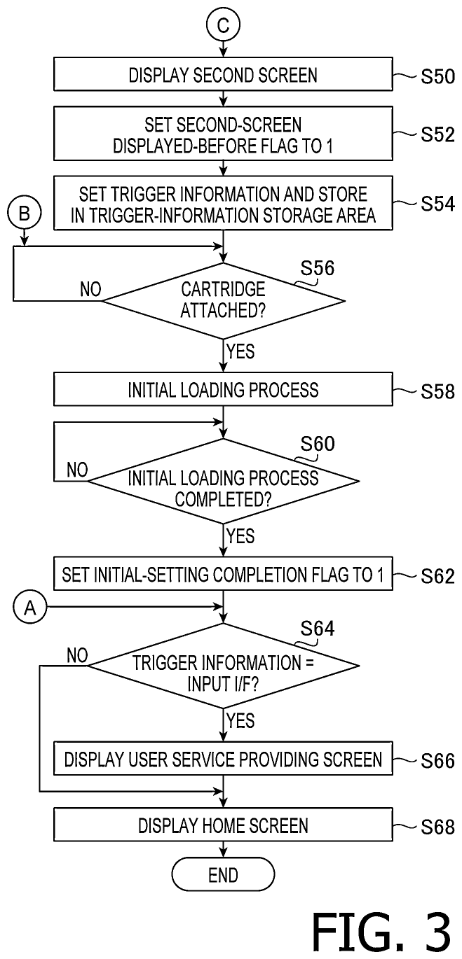

FIGS. 2A-2B and 3 illustrate steps in a powered-on process to be executed by the CPU 52 in the MFP 50 within the communication system 1. The powered-on process starts in response to power being supplied to the MFP 50 based on input of an instruction for power supply to the MFP 50. Power supply to the MFP 50 may be instructed by, for example, a power switch being turned on while the MFP 50 is not powered or by the touch panel being operated or data being received through the network I/F 56 while the MFP 50 is in a sleep mode. The power switch may be, for example, a hardware key included in the input I/F 60. In the description below, steps in the processes will be referred to with a sign “S.”

In response to the power supply to the MFP 50, the powered-on process starts, and the CPU 52 determines whether an initial-setting completion flag stored in the data-storage area 68 in the memory 54 is set to 1 (S10). The initial-setting completion flag is set to 1 when an initial-setting process in the MFP 50 is completed, and an initial value thereof is 0 (zero).

The initial-setting process in the MFP 50 in the present embodiment includes, for example, a password-setting process to set a password for an administrator of the MFP 50, a time-setting process, and an initial loading process in which the printer 61 is loaded with ink or toner. However, the initial-setting processes may not be limited to these three processes but may include one or two of these processes, or another process(es) may replace or may be added to these three processes.

If the CPU 52 determines that the initial-setting completion flag is 1 (S10: YES), the CPU 52 determines whether trigger information indicates “input I/F” (see S64 in FIG. 3). The trigger information and S64 will be described later in detail. On the other hand, if the initial-setting completion flag is zero (S10: NO), the CPU 52 determines whether a second-screen displayed-before flag is set to 1 (S12). The second-screen displayed-before flag is set to 1 when a second screen is displayed on the LCD 58, and an initial value thereof is 0 (zero). The second screen will be described further below with reference to S50.

If the CPU 52 determines that the second-screen displayed-before flag is zero (S12: NO), the CPU 52 determines whether a password-changed flag stored in the data-storage area 68 of the memory 54 is set to 1 (S14). The password-changed flag is set to 1 when an initial password for an administrator stored in the data-storage area 68 of the memory 54 is updated with a newly input password, and an initial value thereof is 0 (zero).

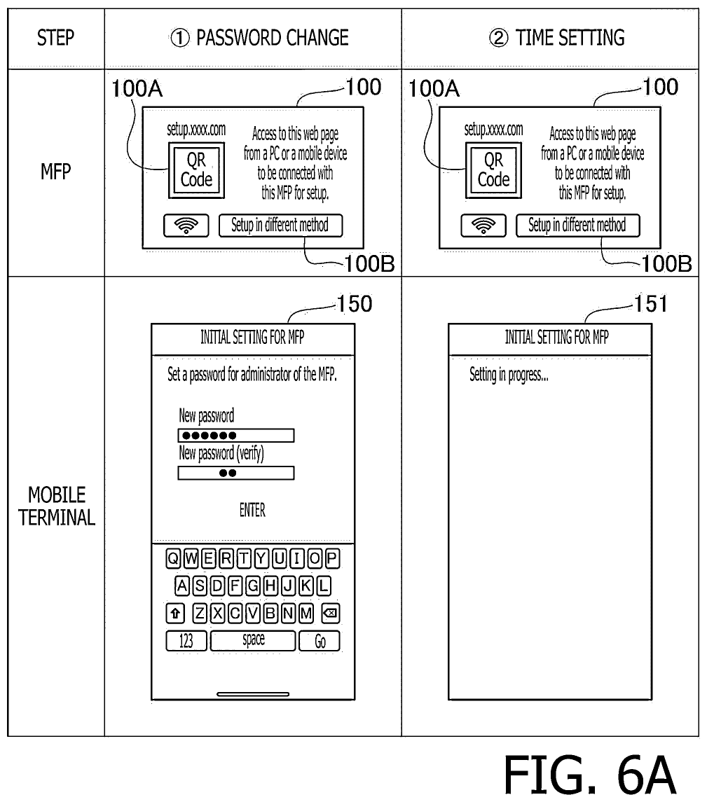

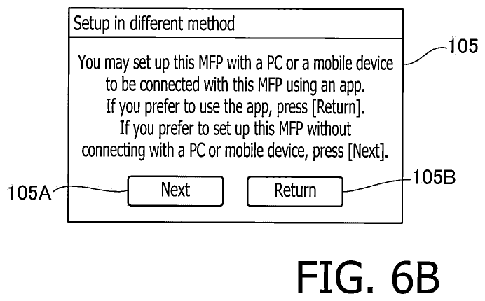

If the CPU 52 determines that the password-changed flag is zero (S14: NO), the CPU 52 controls the LCD 58 to display a first screen (S16). FIG. 6A illustrates a first screen 100 being an example of the first screen to be displayed on the LCD 58. The first screen 100 includes a QR Code 100A. QR Code is a registered trademark of DENSO WAVE INCORPORATED. At a position above the QR Code 100A, an address (e.g., setup.xxx.com) that the QR Code 100A indicates, is displayed in text. Moreover, at a rightward position with respect to the QR Code 100A, an instruction for setting up the mobile terminal 10 with use of the first screen 100 and a setup-in-different-method button 100B are displayed.

While the first screen 100 is being displayed, the user may capture an image of the QR Code 100A with a camera in the mobile terminal 10. In response, the CPU 12 in the mobile terminal 10 analyzes the captured QR Code 100A and accesses to the address (setup.xxxx.com) included in the QR Code 100A with the network I/F 16. Further, the CPU 12 downloads and installs the initial-setting application 30, by which the CPU 12 is enabled to execute the initial-setting process for the MFP 50, from the service-providing server 70. In a case where the mobile terminal 10 is not capable of analyzing the QR Code 100A, in a reason such that, for example, the mobile terminal 10 is not equipped with a camera to capture the QR Code 100A, the user may input the address in text through the touch panel 22, and the mobile terminal 10 may access the designated address, download the initial-setting application 30 from the service-providing server 70, and install the downloaded initial-setting application 30.

As the initial-setting application 30 is installed in the mobile terminal 10 and the user instructs the mobile terminal 10 to activate the initial-setting application 30, the initial-setting application 30 activates. Through the initial-setting application 30, the user may select the MFP 50 among other devices, if any, connected to the network 200. If the initial settings of the MFP 50 are incomplete by the time when the user selects the MFP 50, the initial settings may be completed in cooperation with the initial-setting application 30 on the mobile terminal 10. In particular, the initial-setting application 30 on the mobile terminal 10 controls the LCD 20 to display an administrator's password setting screen 150 as shown in, for example, FIG. 6A.

Through the administrator's password setting screen 150, when the user inputs a password for the administrator and selects a button to enter the password, the initial-setting application 30 transmits an execution instruction to cause the MFP 50 to update the password for the administrator to the MFP 50. The CPU 52 in the MFP 50 receives the password for the administrator through the network I/F 56 and stores the received password in the data-storage area 68 in the memory 54. As such, the setting process to set the password for the administrator is executed.

Next, the initial-setting application 30 controls the LCD 20 to display a setting-in-progress screen 151 as shown in, for example, FIG. 6A. Moreover, the initial-setting application 30 reads current time set in the mobile terminal 10 and transmits time information concerning the current time and an execution instruction to cause the MFP 50 to set the current time to the MFP 50. The CPU 52 in the MFP 50 receives the time information through the network I/F 56 and stores the time information in the data-storage area 68 in the memory 54. As such, the setting process to set the current time is executed.

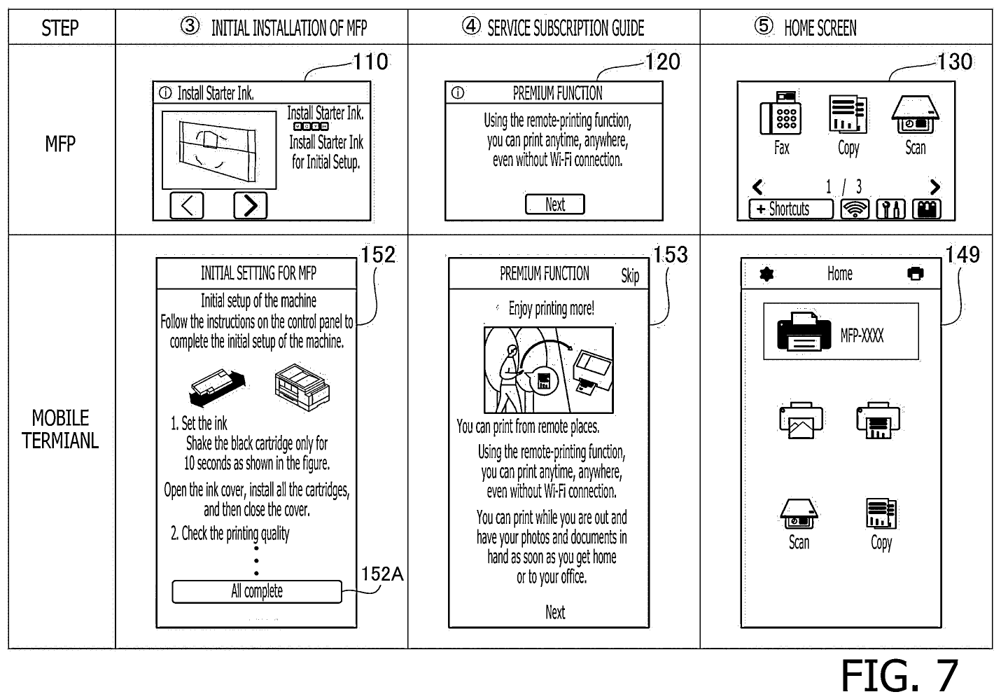

Next, the initial-setting application 30 controls the LCD 20 to display a setup guidance screen 152 for setting up the MFP 50 as shown in, for example, FIG. 7 and transmits a start instruction for the initial loading process to the MFP 50. As such, a process to load the printer 61 with ink or toner is executed. The setup guidance screen 152 may include a message to inform the user of a procedure necessary for the initial loading process and an all-complete button 152A, through which the user may confirm completion of the necessary procedure being guided.

In the present embodiment, the mobile terminal 10 and the MFP 50 may exchange information using, for example, Simple Network Management Protocol (SNMP). In the present embodiment, the mobile terminal 10 serves as an SNMP manager and the MFP 50 serves as an SNMP agent, through Management Information Base (MIB). Meanwhile, a protocol to exchange information between the mobile terminal 10 and the MFP 50 is not necessarily limited but may be a different protocol optionally.

Referring back to FIG. 2A, next, the CPU 52 determines whether the setup-in-different-method button 100B displayed on the LCD 58 is selected (S18). If the CPU 52 determines that the setup-in-different-method button 100B is selected (S18: YES), the CPU 52 controls the LCD 58 to display a setup-in-different-method screen 105 (S40), as shown in FIG. 6B, suggesting a method for setting up the MFP 50 with use of the input I/F 60 of the MFP 50 to the user. The setup-in-different-method screen 105 includes a message which informs the user of a method for setting up the MFP 50 using the mobile terminal 10, a message which informs the user of a method for setting up the MFP 50 not using the mobile terminal 10 but using the input I/F 60, a next button 105A, and a return button 105B. If the CPU 52 determines that the setup-in-different-method button 100B is not selected (S18: NO), the CPU 52 proceeds to S20 (see FIG. 2B).

The CPU 52 waits until the new password and the execution instruction for updating the initial password with the new password are received (S20: NO). As described above, when the user inputs the new password for the administrator through the administrator's password setting screen 150 and selects the enter button, the initial-setting application 30 transmits a password-transmitting MIB command including the new password for the administrator having been input to the MFP 50 through the network I/F 16. In response, the CPU 52 of the MFP 50 receives the password-transmitting MIB command through the network I/F 56. In S20, receiving the new password for the administrator and the execution instruction for updating the password for the administrator means receiving the password-transmitting MIB command including the new password for the administrator through the network I/F 56.

In S20, when the CPU 52 receives the new password for the administrator (S20: YES), the CPU 52 updates the initial password for the administrator stored in the data-storage area 68 with the new password for the administrator included in the password-transmitting MIB command (S22) and sets the password-changed flag to 1 (S24). The CPU 52 proceeds to S26.

On the other hand, in S14, if the password-changed flag is 1 (S14: YES), the CPU 52 skips S16-S24 and proceeds to S26 (see FIG. 2B).

In S26, the CPU 52 determines whether a time-setting completion flag in the data-storage area 68 in the memory 54 is set to 1. The time-setting completion flag is set to 1 when a time setting in the MFP 50 is completed, and an initial value thereof is zero (0).

In S26, if the time-setting completion flag is zero (S26: NO), the CPU 52 waits until the time information and an execution instruction for setting the current time are received (S28: NO). The initial-setting application 30 may read the current time set in the mobile terminal 10 and generate a time-setting MIB command including information of the current time and transmit the generated time-setting MIB command to the MFP 50 through the network I/F 16. In S28, receiving the time information and the execution instruction for setting the current time may mean receiving the time-setting MIB command including the information of the current time through the network I/F 56.

In S28, when the CPU 52 receives the time information (S28: YES), the CPU 52 sets the current time in the MFP 50 based on the information of the current time included in the time-setting MIB command and sets the time-setting completion flag to 1. The CPU 52 proceeds to S34 thereafter.

On the other hand, in S26, if the time-setting completion flag is 1 (S26: YES), the CPU 52 skips S28-S32 and proceeds to S34 (see FIG. 2A).

In S34, the CPU 52 waits until a start instruction for the initial loading process is received (S34: NO). If the CPU 52 receives the start instruction (S34: YES), the CPU 52 proceeds to S50 (see FIG. 3). For instructing the MFP 50 to start the initial loading process, the initial-setting application 30 executes Set Request to send an initial loading process start MIB command to the MFP 50. Alternatively, the start instruction for the initial loading process may be entered through the input I/F 60. For example, when the setup-in-different-method screen 105 suggesting the method for setting up the MFP 50 with use of the input I/F 60 of the MFP 50 is displayed in S40 and when the next button 105A is selected through the setup-in-different-method screen 105 (S42: YES), the CPU 52 may proceed to S34 and determine that the start instruction for the initial loading process is received (S34: YES). Meanwhile, when the return button 105B is selected through the setup-in-different-method screen 105 (S42: NO), the CPU 52 returns to S16 and controls the LCD 58 to display the first screen 100. As such, the screen on the LCD 58 returns from the setup-in-different-method screen 105 to the previously displayed first screen 100.

In S50 shown in FIG. 3, the CPU controls the LCD 58 to display the second screen. FIG. 7 illustrates a screen 110, which is an example of the second screen, informing the user of a procedure necessary for the initial loading process in the MFP 50 and guiding the user to attach a starter cartridge to the MFP 50. Further, in S52, the CPU 52 sets a second-screen displayed-before flag to 1. Optionally, if the MFP 50 is equipped with a tank in place of the cartridge compartment 65, the second screen 110 may guide the user to load the tank with a corresponding colorant.

Next, the CPU 52 sets the trigger information in a trigger-information storage area (not shown) in the data-storage area 68 in the memory 54 (S54). The trigger information indicates through which route, i.e., from either the mobile terminal 10 or the input I/F 60, the start instruction for the initial loading process was entered. In other words, the trigger information may indicate whether the start instruction for the initial-setting process was triggered by the mobile terminal 10 or the input I/F 60. In this regard, the trigger-information storage stores one of “unentered,” “mobile terminal,” and “input I/F.” While in the present embodiment the mobile terminal 10 may be the only external terminal in the communication system 1, if the external terminal includes not only the mobile terminal 10 but also, for example, a PC, the trigger-information storage area may store one of “unentered,” “mobile terminal,” “PC,” and “input I/F.” The trigger information may be used as log information concerning the start instruction for the initial loading process.

Next, the CPU 52 determines whether the cartridge is attached to the MFP 50 based on a detected outcome from the detection sensor provided in the cartridge compartment 65. In the case where the MFP 50 is equipped with the tank in place of the cartridge compartment 65, the CPU 52 may determine whether the tank is loaded with a predetermined threshold amount or a larger amount of the corresponding colorant. If the CPU 52 determines that the cartridge is not attached to the MFP 50 (S56: NO), the CPU 52 repeats S56. If the CPU 52 determines that the cartridge is attached to the MFP 50 (S56: YES), the CPU 52 executes the initial loading process (S58) and controls the LCD 58 to display a screen indicating that the initial loading process is in progress. The initial loading process is a preparation process before the printer 61 prints an image on a sheet and may include a process to agitate the toner contained in the cartridge, in the case where, for example, the printer 61 is an electro-photographic printer. For another example, in the case where the printer 61 is an inkjet printer, the initial loading process may include a process to supply the ink from the cartridge to the inkjet head. For another example, the initial loading process may include a process to correct a printing position on a printing medium and a test-printing process.

Next, the CPU 52 continues the initial loading process until the initial loading process is completed (S60: NO). When the initial loading process is completed (S60: YES), the CPU 52 sets the initial-setting completion flag to 1 (S62).

Next, the CPU 52 reads the trigger information stored in the trigger-information storage area in the memory 54 and determines based on the trigger information whether “input I/F” is set as the trigger information (S64). If the CPU 52 determines that “input I/F” is set as the trigger information (S64: YES), the CPU 52 controls the LCD 58 to display a user service providing screen. FIG. 7 illustrates a screen 120, which is an example of the user service providing screen, informing the user of functions of the MFP 50 and services available from the service-providing server 70. The exemplary screen 120 shown in FIG. 7 includes a message to inform the user of a remote-printing function and a next button. If the user selects the next button in the user service providing screen 120, the MFP 50 transmits information to identify the MFP 50, such as IP address, to the service-providing server, and the service-providing server 70 stores the information from the MFP 50 in a storage thereof. As such, the remote-printing function provided by the service-providing server 70 becomes available to the MFP 50.

On the other hand, if the CPU 52 determines that “mobile terminal” is stored as the trigger information (S64: YES), the CPU 52 controls the LCD 58 to display a home screen (S68), and thereafter ends the powered-on process. FIG. 7 illustrates a home screen 130 being an example of the home screen. The home screen 130 includes icons to activate functions provided to the MFP 50, such as facsimile transmission, copying, and scanning, and an icon indicating remaining amounts of the colorants, and a setting icon.

In S12, if the second-screen displayed-before flag indicates 1 (S12: YES), the CPU 52 controls the LCD 58 to display the second screen 110 (S48) and proceeds to S56 (see FIG. 3). In response to the determination that the cartridge is attached to the MFP 50 (S56: YES), the CPU 52 proceeds to S58. In the case where the CPU 52 proceeds to S58, it may be understood that, while the initial-setting process is incomplete, the second screen 110 had been displayed before the powered-on process started. In other words, after the initial-setting application 30 on the mobile terminal 10 displayed the setup guidance screen 152, the power supply to the MFP 50 was discontinued, and thereafter the power supply to the MFP 50 was resumed. In this case, the CPU 52 controls the LCD 58 to display the second screen 110 skipping the first screen 100.

Thereafter, at the time when the initial-setting process with the MFP 50 is completed, in particular, when an all-complete button 152A in the setup guidance screen 152 as shown in FIG. 7 is pressed, the initial-setting application 30 transmits an inquiry to the MFP 50 about whether the initial-setting process is completed. In response, the CPU 52 of the MFP 50 may transmit a reply indicating that the initial-setting process is completed. If the mobile terminal 10 receives the reply from the MFP 50, the initial-setting application 30 controls the LCD 20 to display a user service providing screen 153 as shown in, for example, FIG. 7. The user service providing screen 153 may include a message to inform the user of the remote-printing function and a next button. If the user selects the next button in the user service providing screen 153, the LCD 20 may display a home screen 149. Optionally, the selection of the next button by the user may direct the user to a process through which the user may subscribe to the remote-printing service.

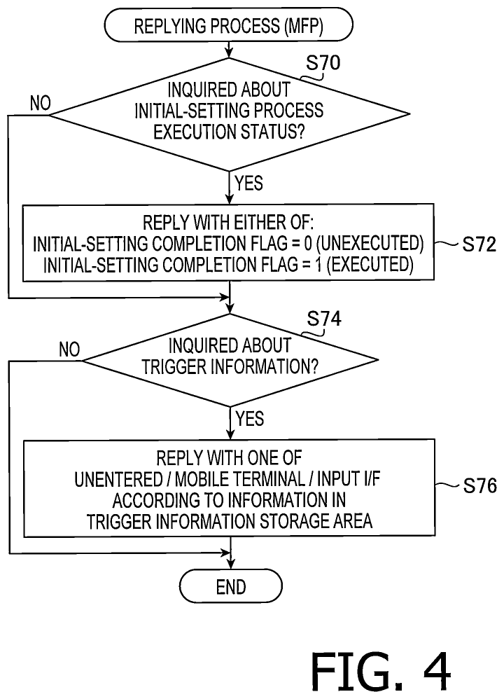

FIG. 4 is a flowchart illustrating steps in a replying process to be executed by the CPU 52 in the MFP 50. The replying process is a process to reply to an inquiry to the MFP 50 from the initial-setting application 30 and may be repeated by the CPU 52 at predetermined time intervals.

As shown in FIG. 4, first, the CPU 52 determines whether an inquiry about an initial-setting process execution status from the initial-setting application 30 has been received (S70). The initial-setting application 30 may inquire by, for example, executing Get Request to send an initial-setting process execution status MIB command to the MFP 50.

In S70, if the inquiry concerning the initial-setting process execution status from the initial-setting application 30 has been received (S70: YES), and in a case where the initial-setting completion flag is set to zero, the CPU 52 generates an initial-setting process execution status MIB reply including information that indicates the initial-setting process is “unexecuted” and sends the reply to the initial-setting application 30. On the other hand, in a case where the initial-setting completion flag is 1, the CPU 52 generates an initial-setting process execution status MIB reply including information that indicates the initial-setting process is “executed” and sends the reply to the initial-setting application 30 (S72). The CPU 52 proceeds to S74.

In S70, on the other hand, if no inquiry about the initial-setting process execution status from the initial-setting application 30 has been received (S70: NO), the CPU 52 skips S72 and proceeds to S74.

In S74, the CPU 52 determines whether an inquiry about trigger information from the initial-setting application 30 has been received. The initial-setting application 30 may inquire by, for example, executing Get Request to send an initial-setting start MIB command to the MFP 50.

In S74, if an inquiry about trigger information from the initial-setting application 30 has been received (S74: YES), the CPU 52 reads the trigger information stored in the trigger information storage area, generates an initial-setting process start MIB reply including information that indicates one of “unentered,” “mobile terminal,” or “input I/F” according to the trigger information, and sends the reply to the initial-setting application 30. Thereafter, the CPU 52 ends the replying process.

In S74, on the other hand, if no inquiry about trigger information from the initial-setting application 30 has been received (S74: NO), the CPU 52 skips S76 and ends the replying process.

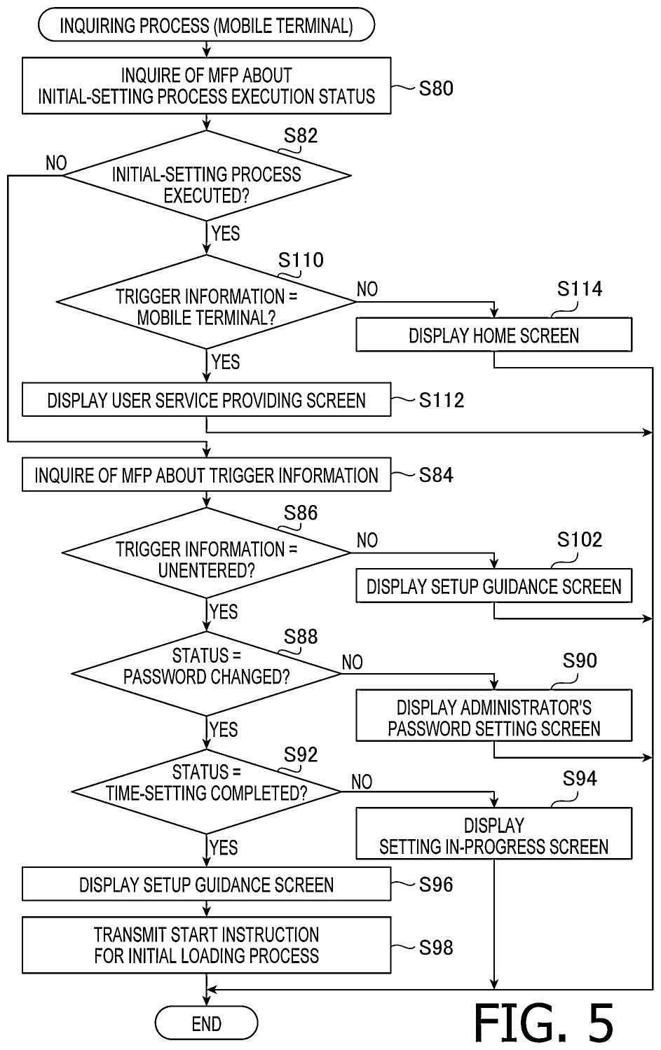

FIG. 5 is a flowchart illustrating steps in an inquiring process to be executed by the CPU 12 in the mobile terminal 10. The inquiring process is a process to inquire of the MFP 50 about whether the initial-setting process is completed. The inquiring process may be executed by the CPU 12 when, for example, the initial-setting application 30 is terminated for some reason at the moment when all-complete button 152A in the setup guidance screen 152 is pressed, or before the initial-setting application 30 completes the initial-setting process for the MFP 50 and thereafter is restarted.

As shown in FIG. 5, first, the CPU 12 inquires of the MFP 50 if the initial-setting process execution status is “executed” (S80). In particular, initial-setting application 30 may inquire by, for example, executing Get Request to send the initial-setting process execution status MIB command to the MFP 50.

Next, the CPU 12 determines whether the initial-setting process execution status is “executed” based on a return value included in the initial-setting process execution status MIB reply (S82). If the CPU 12 determines that the initial-setting process execution status is “executed” (S82: YES), the CPU 12 inquires of the MFP 50 about the trigger information and determines whether a reply from the MFP 50 is the mobile terminal or not (S110). If the CPU 12 determines that the reply is the mobile terminal (S110: YES), the CPU 12 controls the LCD 20 to display a user service providing screen 153 shown in FIG. 7 (S112). Thereafter, the CPU 12 ends the inquiring process. On the other hand, if the reply from the MFP 50 about the trigger information is not the mobile terminal but is the input I/F (S110: NO), the CPU 12 controls the LCD 20 to display the home screen 149 shown in FIG. 7 (S114). As shown in FIG. 7, the home screen 149 displays status information in an upper area and icons in a lower area. The status information in the upper area may include, for example, a device name of the MFP 50 that executed the initial-setting process and amounts of remaining inks. The icons in the lower area may represent functions that are available from the MFP 50. When the initial-setting process execution status is “executed,” as described above, the initial-setting completion flag is 1. Moreover, when the initial setting completion flag is 1, and in the case where the trigger information indicates “input I/F”, the LCD 58 of the MFP 50 displays the user service providing screen 120 as shown in FIG. 7, and the LCD 20 of the mobile terminal 10 displays the home screen 149 as shown in FIG. 7. On the other hand, in the case where the trigger information is “mobile terminal”, the LCD 20 of the mobile terminal 10 displays the user service providing screen 153 as shown in FIG. 7, and the LCD 58 of the MFP 50 indicates the home screen 130 as shown in FIG. 7. Optionally, in a case where the user is subscribed to the service shown in the user service providing screen, both the LCD 20 of the mobile terminal 10 and the LCD 58 of the MFP 50 may display the home screens 149, 130.

On the other hand, in S82, if the initial-setting process execution status is “unexecuted” (S82: NO), the CPU 12 inquires of the MFP 50 about the trigger information (S84). In particular, as described above, the initial-setting application 30 may execute Get Request to send the initial-setting process start MIB command to the MFP 50.

Next, the CPU 12 determines whether the trigger information is “unentered” (S86) based on the return value from the initial-setting process start MIB command. If the trigger information is “unentered” (S86: YES), the initial-setting application 30 determines whether a status indicates that the password has been changed (S88). The initial-setting application 30 stores a status, which indicates how far the initial-setting process progressed, in a status area (not shown) in the data-storage area 32 in the memory 14. The status may indicate, for example, either “password changed” or “time-setting completed.”

In S88, if the status is password unchanged (S88: NO), the initial-setting application 30 controls the LCD 20 to display an administrator's password setting screen 150 as shown in FIG. 6A (S90) and ends the inquiring process thereafter. In the case where the initial-setting process execution status is unexecuted, the trigger information is unentered, and the status is password unchanged, it may be understood that the CPU 52 in the MFP 50 has not executed the process in S22 (see FIG. 2B); therefore, the initial-setting application 30 controls the LCD 20 to display the administrator's password setting screen 150.

On the other hand, in the case where the status is password changed (S88: YES), the initial-setting application 30 determines whether the status is time-setting completed (S92). If the CPU 12 determines that the status is time-setting incomplete (S92: NO), the initial-setting application 30 controls the LCD 20 to display the setting in-progress screen 151 as shown in FIG. 6A (S94) and ends the inquiring process. In the case where the initial-setting process execution status is unexecuted, the trigger information indicates unentered, and the status is time-setting incomplete, it may be understood that the CPU 52 in the MFP 50 has executed the process in S22 (see FIG. 2B) but has not executed the process in S30 (see FIG. 2B). Therefore, the initial-setting application 30 controls the LCD 20 to display the setting in-progress screen 151 as shown in FIG. 6A.

In S92, on the other hand, if the CPU 12 determines that the status is time-setting completed (S92: YES), the initial-setting application 30 controls the LCD 20 to display the setup guidance screen 152 as shown in FIG. 7 and transmits the start instruction for the initial loading process to the MFP 50 (S98). Thereafter, the CPU 12 ends the inquiring process. For instructing the MFP 50 to start the initial loading process, as described above, the initial-setting application 30 executes Set Request to send the initial loading process start MIB command to the MFP 50. In the case where the initial-setting process execution status is unexecuted, the trigger information is unentered, and the status is time-setting completed, it may be understood that the CPU 52 in the MFP 50 has executed the process in S22 and S30 (see FIG. 2B) but has not executed the process in S50 (see FIG. 3). Therefore, the initial-setting application 30 controls the LCD 20 to display the setup guidance screen 152 as shown in FIG. 7.

In S86, on the other hand, if the CPU determines that the trigger information is not unentered (S86: NO), the initial-setting application 30 controls the LCD 20 to display the setup guidance screen 152 as shown in FIG. 7 (S102) and ends the inquiring process thereafter. The trigger information not unentered means that the CPU 52 of the MFP 50 has received the start instruction for the initial loading process from either the mobile terminal or the input I/F 60 (S34: YES). Therefore, the initial-setting application 30 displays the setup guidance screen 152 but does not transmit the start instruction for the initial loading process redundantly.

After the inquiring process ends, the initial-setting application 30 may continuously execute a process depending on the screen displayed at the end of the inquiring process, i.e., one of the administrator's password setting screen 150, the setting in-progress screen 151, the setup guidance screen 152, the user service providing screen 153, and the home screen 149.

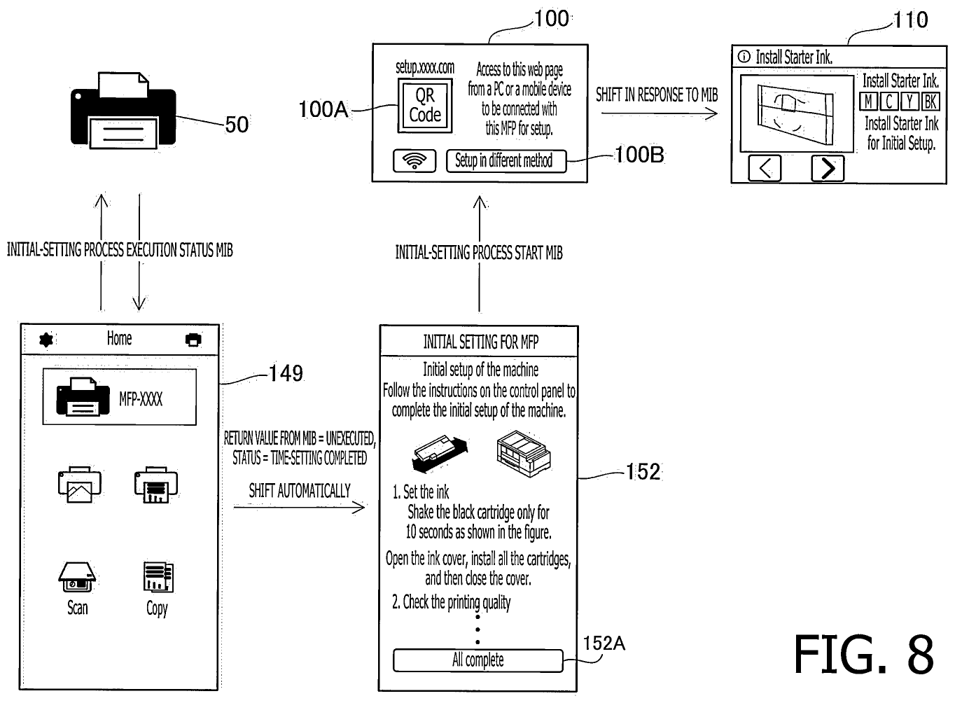

FIG. 8 is an illustrative view of the screens when the initial-setting application 30 returns from a terminated state and executes the inquiring process, under the condition where the initial-setting process execution status is unexecuted, the trigger information is unentered, and the status of time-setting is completed.

As shown in FIG. 8, when the initial-setting application 30 returns from the terminated state, the initial-setting application 30 controls the LCD 20 to display the home screen 149 and executes Get Request to send the initial-setting process execution status MIB command to the MFP 50. In return, the initial-setting application 30 receives a return value from an initial-setting process execution status MIB reply and recognizes that the initial-setting process execution status of the MFP 50 is unexecuted. Therefore, the initial-setting application 30 executes Get Request to send the initial-setting process start MIB command to the MFP 50. In return, the initial-setting application 30 receives a return value from the initial-setting process start MIB reply and recognizes that the trigger information of the MFP 50 is unentered. At this instance, the status of the initial-setting application 30 concerning the time setting is “time-setting completed.” Therefore, the initial-setting application 30 controls the LCD 20 to display the setup guidance screen 152 (see S96 in FIG. 5). Meanwhile, the LCD 58 of the MFP 50 is displaying the first screen 100.

As the initial-setting application 30 executes Set Request to send the initial-setting process start MIB command to the MFP 50 (S98 in FIG. 5), the CPU 52 of the MFP 50 receives the start instruction for the initial loading process through the network I/F 56 (S34: YES in FIG. 2A) and controls the LCD 58 to display the second screen 110 (S50 in FIG. 3). In other words, the screen on the LCD 58 shifts from the first screen 100 to the second screen 110.

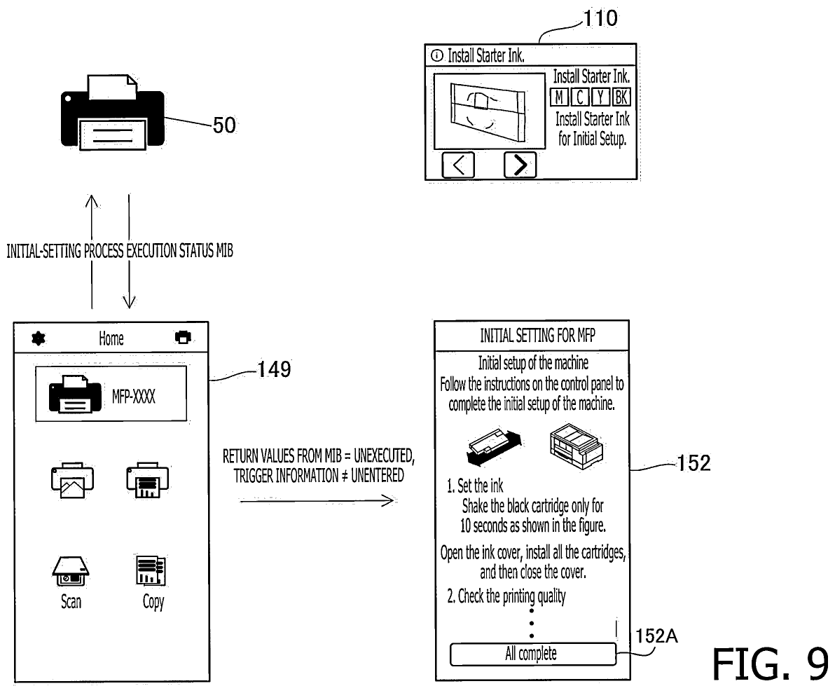

FIG. 9 is an illustrative view of the screens when the initial-setting application 30 executes the inquiring process, under the condition where the initial-setting process execution status is unexecuted and the trigger information is not unentered.

As shown in FIG. 9, as the initial-setting application 30 returns from the terminated state, the initial-setting application 30 controls the LCD 20 to display the home screen 149 and executes Get Request to send the initial-setting process execution status MIB command to the MFP 50. In return, the initial-setting application 30 receives a return value from the initial-setting process execution status MIB reply and recognizes that the initial-setting process execution status of the MFP 50 is unexecuted. Therefore, the initial-setting application 30 executes Get Request to send the initial-setting process start MIB command to the MFP 50. In return, the initial-setting application 30 receives a return value from the initial-setting process start MIB reply and recognizes that the trigger information of the MFP 50 is not unentered. At this instance, the status of the initial-setting application 30 concerning the time setting is “time-setting incomplete.” Therefore, the initial-setting application 30 controls the LCD 20 to display the setup guidance screen 152 (see S96 in FIG. 5). In the case where the trigger information is not unentered, it may be understood that the CPU 52 of the MFP 50 has made an affirmative determination in S34 (S34: YES in FIG. 2A). Therefore, the second screen 110 has been already displayed on the LCD 58 of the MFP 50. Therefore, the LCD 58 continues displaying the second screen 110 without shifting to another screen.

According to the present embodiment, on the side of the MFP 50, the flags, i.e., the password-changed flag, the time-setting completion flag, and the second-screen displayed-before flag, are provided; and on the side of the initial-setting application 30, statuses, i.e., the password-changed status and the time-setting completion status, which function similarly to the flags, are provided, so that the MFP 50 and the initial-setting application 30 may use the flags and the statuses, respectively. However, both of the flags and the statuses may not necessarily be provided. For example, solely the MFP 50 may be provided with the flags, and the initial-setting application 30 may use these flags by inquiring of the MFP 50 about the flags through the MIB. In this arrangement, the MFP 50 and the initial-setting application 30 may execute the respective processes based on the shared information. Therefore, processes contradictory to one another between the MFP 50 and the initial-setting application 30 may be avoided.

As described above, the MFP 50 in the present embodiment includes the network I/F 56, the input I/F 60, and the CPU 52. The CPU 52 is configured to, in response to receiving of the instruction to supply power to the MFP 50 from the input I/F 60, determine whether the initial-setting process in the MFP 50 is completed or incomplete (S10). If the CPU 52 determines that the initial-setting process is incomplete (S10: NO), the CPU 52 is configured to wait for the execution instruction for causing the MFP 50 to execute the initial-setting process with use of the mobile terminal 10 (S20, S28, and S24). If the execution instruction is received from the mobile terminal 10 through the network I/F 56 (S20: YES, S28: YES, and S34: YES) while waiting for the execution instruction, execute the initial-setting process for the MFP 50 (S22, S30, and S58).

As such, according to the MFP 50 in the present embodiment, if the initial setting of the MFP 50 is incomplete, the initial setting may be processed in response to receiving of the execution instruction from the mobile terminal 10. Therefore, when, for example, the user of the mobile terminal 10 is remote from the MFP 50, the MFP 50 may still be operated to execute the initial-setting process, and the workload for the initial setting may be reduced.

Meanwhile, if the execution instruction is received from the mobile terminal 10 through the network I/F 56 while not waiting for the execution instruction, the CPU 52 does not execute the initial-setting process for the MFP 50.

In the case where the CPU 52 receives the execution instruction from the mobile terminal 10 even though the CPU 52 is waiting for the execution instruction, it may be considered as an error such that the user of the mobile terminal 10 erroneously selected the MFP 50 as an addressee of the start instruction for the initial loading process, and the mobile terminal 10 transmitted the start instruction to the MFP 50 rather than a different communication apparatus. In such an occasion, according to the present embodiment, the CPU 52 refuses the instruction, and the initial-setting process is prevented from being executed erroneously.

Moreover, after the initial-setting process is started (S22, S30, and S58) and if the execution instruction is received from the mobile terminal 10 through the network I/F, the CPU 52 ignores the received execution instruction. Therefore, if the CPU 52 receives the execution instruction multiple times, the execution instructions received later are ignored. Accordingly, the initial-setting process may be prevented from being executed redundantly.

Meanwhile, after starting to wait for the execution instruction (S20, S28, and S34) and if the execution instruction is received from the input I/F 60 (S42: YES), in response, the CPU 52 executes the initial-setting process (S58). Therefore, the initial setting may be processed without using the mobile terminal 10.

The MFP 50 according to the present embodiment includes the memory 54, and the CPU 52 may store the initial-setting completion flag, indicating whether the initial-setting process is completed or incomplete, and the trigger information, indicating from which one of the mobile terminal 10 or the input I/F 60 the start instruction for the completed initial loading process was received, in the memory 54 (S54, S62). Therefore, the MFP 50 may execute the process based on the initial-setting completion flag and the trigger information.

Moreover, the MFP 50 according to the present embodiment includes the LCD 58. If the trigger information indicates the input I/F 60 (S64: YES), the CPU 52 controls the LCD 58 to display the user service providing screen 120, which is an example of the predetermined screen, and if the trigger information indicates the mobile terminal 10, the CPU 52 controls the LCD 58 not to display the user service providing screen 120. In other words, the screen to be displayed on the LCD 56 of the MFP 50 differs depending on whether the initial-setting process is executed with use of the mobile terminal 10 or not. As such, the MFP 50 may alter whether or not to display the user service providing screen 120 based on the trigger information; therefore, a preferable screen may be displayed on the LCD 58. Optionally, the predetermined screen may be, for example, a screen to guide the user to installation of an application program, by which the mobile terminal 10 may control the MFP 50.

Moreover, the CPU 52 transmits a reply to the mobile terminal 10 based on the initial-setting completion flag or the trigger information stored in the memory 54 in response to the inquiry received from the mobile terminal 10 through the network I/F 56 (S72, S76). Therefore, the mobile terminal 10 may execute a process, for example, to determine whether a start instruction to start a process is to be transmitted to the MFP 50, based on the reply from the MFP 50.

The initial-setting process includes a first initial-setting process (S22) and a second initial-setting process (S30) different from the first initial-setting process, and the completion flags (i.e., the password-changed flag and the time-setting completion flag) indicate whether the first initial-setting process is completed or incomplete and whether the second initial-setting process is completed or incomplete. Therefore, the CPU 52 may execute a process, i.e., a process based on the first initial-setting process or a process based on the second initial-setting process, depending on the flag referring to.

The execution instruction that the CPU 52 waits for includes a first execution instruction (S20) to execute the first initial-setting process in the MFP 50 with use of the mobile terminal 10 and a second execution instruction (S28) to execute the second initial-setting process in the MFP 50 with use of the mobile terminal 10. In the case where the CPU 52 receives the first execution instruction for the first initial-setting process from the mobile terminal 10 through the network I/F 56 while waiting for the first execution instruction (S20: YES), the CPU 52 executes the first initial-setting process (S22). In the case where, after executing the first initial-setting process and while waiting for the second execution instruction (S28), the CPU 52 receives the start instruction for the second initial-setting process from the mobile terminal 10 through the network I/F 56 (S28: YES), the CPU 52 executes the second initial-setting process in the MFP 50 (S30). Therefore, in a case where the initial-setting process includes a plurality of setting processes, the setting processes may be executed in an order according to the instructions from the mobile terminal 10. Optionally, the first initial-setting process may be any one of the S22, S30, and S58, and the second initial-setting process may be any another one of the S22, S30, and S58 as long as the first initial-setting process and the second initial process are different.

The MFP 50 includes the printer 61 for forming an image on a sheet, and the CPU 52 may prepare the printer 61 for forming the image on the sheet (S58) in the initial-setting process. Accordingly, the printer 61 may be prepared for forming an image with use of the mobile terminal 10.

As described above, the computer readable instructions stored in the non-transitory computer-readable storage medium according to the present embodiment are executable by the CPU 12 in the mobile terminal 10 including the network I/F 16. The computer readable instructions may cause the CPU 12 to inquire about the completion status of the initial-setting process in the MFP 50 through the network I/F 16 (S80). If the CPU 12 receives a reply indicating that the initial-setting process is incomplete in response to the inquiry (S82: NO), the CPU 12 transmits the execution instruction instructing the MFP 50 to execute the initial-setting process to the MFP 50 (S98).

As such, in the case where the reply indicating that the initial-setting process is incomplete is received from the MFP 50, the computer readable instructions cause the CPU 12 of the mobile terminal 10 to transmit the execution instruction to instruct the MFP 50 to execute the initial-setting process, to the MFP 50. Therefore, when, for example, the user of the mobile terminal 10 is remote from the MFP 50, the MFP 50 may still be operated to execute the initial-setting process, and the workload for the initial setting may be reduced.

Meanwhile, in response to the inquiry from the mobile terminal 10, the MFP 50 may reply with the initial-setting process completion status and a receiving status of the execution instruction (S72, S76). If the reply received from the MFP 50 in response to the inquiry indicates that the initial-setting process is incomplete (S82: NO) and the execution instruction has not been received (S86: YES), the CPU 12 transmits the execution command to the MFP 50.

As such, in the case where the CPU 12 receives the replies from the MFP 50, informing that the initial-setting process is incomplete and the execution instruction has not been received, the CPU 12 transmits the execution instruction to the MFP 50. In other words, in a case where the initial setting is completed and the execution instruction is received in the MFP 50, the execution instruction to execute the initial loading process is not transmitted to the MFP 50. Therefore, unnecessary transmission of the instruction to execute the initial-setting process to the MFP 50 is avoidable.

The mobile terminal 10 further includes the LCD 20, and the computer readable instructions may cause the CPU 12 to, if the CPU 12 receives replies from the MFP 50, informing that the initial-setting process is incomplete (S82: NO) and the execution instruction is received (S86: NO) in response to the inquiry, control the LCD 20 to display the screen showing the procedure of the initial-setting process (S102) without transmitting the execution instruction to the MFP 50. Accordingly, in the case where the CPU 12 receives the replies from the MFP 50, informing that the initial-setting process is incomplete and the execution instruction has been received, the execution instruction to execute the initial loading process is not transmitted to the MFP 50. Therefore, unnecessary transmission of the instruction to execute the initial-setting process to the MFP 50 is avoidable.

As described above, the communication system 1 according to the present embodiment includes the MFP 50 including the network I/F 56, the input I/F 60, and the CPU 52, and the mobile terminal 10 including the network I/F 16. The CPU 52 in the MFP 50 is configured, in response to receiving of the instruction to supply power to the MFP 50 from the input I/F 60, determine whether the initial-setting process in the MFP 50 is completed (S10), and on condition that the CPU 52 determines the initial-setting process is incomplete (S10: NO), wait for the execution instruction for causing the MFP 50 to execute the initial-setting process with use of the mobile terminal 10 (S20, S28, and S34). The mobile terminal 10 is configured to transmit the execution instruction instructing the MFP 50 to execute the initial-setting process through the network I/F 16 (S98). The CPU 52 in the MFP 50 is configured to, on condition that the execution instruction is received from the mobile terminal 10 through the network I/F 56 while waiting for the execution instruction (S20: YES, S28: YES, and S34: YES), execute the initial-setting process for the MFP 50 (S22, S30, and S58).

As such, according to the communication system 1 in the present embodiment, in the case where the initial setting of the MFP 50 is incomplete, and in response to receiving of the execution instruction from the mobile terminal 10, the MFP 50 may process the initial settings. Therefore, when, for example, the user of the mobile terminal 10 is remote from the MFP 50, the MFP 50 may still be operated to execute the initial-setting process, and the workload for the initial setting may be reduced.

While the invention has been described in conjunction with an example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

For example, the communication apparatus according to the present disclosure may not necessarily be limited to the MFP 50 but may be, for example, a single-functioned copier capable of communication.

For another example, the controller according to the present disclosure may not necessarily be limited to the single CPU, but the controller may consist of a plurality of CPUs or may include a CPU consisting of a plurality of cores.

For another example, the code information according to the present disclosure may not necessarily be limited to the QR Code but may be, for example, two-dimensional code, one-dimensional code, or a three-dimensional code.

What is claimed is:

1. A communication apparatus, comprising:
a communication interface; and
a controller configured to:
in response to power supply to the communication apparatus, determine whether an initial-setting process in the communication apparatus is completed or incomplete;
in response to determining that the initial-setting process is incomplete, wait for an execution instruction for executing the initial-setting process for the communication apparatus with use of an external terminal; and
in response to receiving the execution instruction from the external terminal through the communication interface while waiting for the execution instruction, execute the initial-setting process for the communication apparatus.

2. The communication apparatus according to claim 1, wherein, in response to receiving the execution instruction from the external terminal through the communication interface while not waiting for the execution instruction, the controller is configured not to execute the initial-setting process for the communication apparatus.

3. The communication apparatus according to claim 1, wherein the controller is configured to, after the initial-setting process is started and in response to receiving the execution instruction from the external terminal through the communication interface, ignore the received execution instruction.

4. The communication apparatus according to claim 1, wherein the controller is configured to, after starting to wait for the execution instruction and in response to receiving the execution instruction from the input device, execute the initial-setting process.

5. The communication apparatus according to claim 4, further comprising a memory,
wherein the controller is configured to store completion information and trigger information in the memory, the completion information indicating whether the initial-setting process is completed or incomplete, and the trigger information indicating by which one of the external terminal or the input device the execution instruction for the initial-setting process was triggered.

6. The communication apparatus according to claim 5, further comprising a display,
wherein the controller is configured to control the display to:
on condition that the trigger information indicates the input device, display a predetermined screen; and
on condition that the trigger information indicates the external terminal, not display the predetermined screen.

7. The communication apparatus according to claim 6, wherein the predetermined screen is one of:
a screen guiding a user to a service available with use of the communication apparatus; or
a screen guiding the user to installation of an application program for controlling the communication apparatus on the external terminal.

8. The communication apparatus according to claim 5, wherein the controller is configured to transmit a reply based on the completion information or the trigger information stored in the memory in response to receiving an inquiry from the external terminal through the communication apparatus.

9. The communication apparatus according to claim 5, wherein
the initial-setting process includes a first initial-setting process and a second initial-setting process different from the first initial-setting process, and
the completion information indicates whether the first initial setting-process is completed or incomplete and whether the second initial-setting process is completed or incomplete.

10. The communication apparatus according to claim 9, wherein
the execution instruction that the controller waits for includes:
a first execution instruction to execute the first initial-setting process for the communication apparatus with use of the external terminal; and
a second execution instruction to execute the second initial-setting process for the communication apparatus with use of the external terminal, and
the controller is configured to:
in response to receiving the first execution instruction from the external terminal through the communication interface while waiting for the first execution instruction, execute the first initial-setting process for the communication apparatus; and
after executing the first initial-setting process and in response to receiving the second execution instruction from the external terminal through the communication interface, execute the second initial-setting process for the communication apparatus.

11. The communication apparatus according to claim 10, wherein the controller is configured to, on condition that the controller transmitted completion information indicating that the second initial-setting process is incomplete in response to receiving an inquiry from the external terminal through the communication interface, wait for the second execution instruction.

12. The communication apparatus according to claim 1, further comprising an image forming device configured to form an image on a sheet,
wherein, in the initial-setting process, the controller is configured to prepare the image forming device for forming the image.

13. A non-transitory computer-readable storage medium storing computer readable instructions that are executable by a computer in a terminal device including a communication interface, the computer readable instructions, when executed by the computer, causing the terminal device to:
send an inquiry to request a completion status of an initial-setting process for a communication apparatus through the communication interface; and
in response to receiving a reply with the completion status indicating that the initial-setting process is incomplete from the communication apparatus, transmit an execution instruction instructing the communication apparatus to execute the initial-setting process to the communication apparatus.

14. The non-transitory computer-readable storage medium according to claim 13, wherein
the communication apparatus is configured to, in response to receiving the inquiry from the terminal device, send the reply with the completion status of the initial-setting process to the terminal device, the reply including a receiving status of the execution instruction, and
in response to receiving the reply with the completion status indicating that the initial-setting process is incomplete and the receiving status indicating that the execution instruction has not been received from the communication apparatus, the computer readable instructions cause the terminal device to transmit the execution instruction to the communication apparatus.

15. The non-transitory computer-readable storage medium according to claim 13, wherein
the communication apparatus is configured to, in response to receiving the inquiry from the terminal device, send the reply with the completion status of the initial-setting process to the terminal device, the reply including a receiving status of the execution instruction,
the terminal device further includes a display, and
in response to receiving the reply with the completion status indicating that the initial-setting process is incomplete and the receiving status indicating the execution instruction has been received from the communication apparatus, the computer readable instructions cause the terminal device to display a screen showing a procedure of the initial-setting process on the display without transmitting the execution instruction to the communication apparatus.

16. A communication system, comprising:
a communication apparatus including a first communication interface and a controller; and
a terminal device including a second communication interface,
wherein the controller in the communication apparatus is configured to:
in response to power supply to the communication apparatus, determine whether an initial-setting process in the communication apparatus is completed or incomplete; and
in response to determining that the initial-setting process is incomplete, wait for an execution instruction for executing the initial-setting process for the communication apparatus with use of the terminal device,
wherein the terminal device is configured to transmit the execution instruction instructing the communication apparatus to execute the initial-setting process through the second communication interface, and
wherein the controller in the communication apparatus is configured to, in response to receiving the execution instruction from the terminal device through the first communication interface while waiting for the execution instruction, execute the initial-setting process for the communication apparatus.
